(19) United States
(12) Patent Application Publication
(10) Pub. No.: US 2011/0274807 A1
(43) Pub. Date: Nov. 10, 2011

(54) Elastomeric multi-function squeezer/strainer device

(76) Inventor: Robin Haber, Highland Park, IL (US)

(21) Appl. No.: 12/800,158

(22) Filed: May 10, 2010

(51) Int. Cl. A23N 1/00; A23P 1/00

(52) U.S. Cl. 426/489; 99/508

(57) ABSTRACT

The present invention is directed to an elastomeric perforated sheet that can be used as a squeezer, strainer, juicer, sieve, or sachet. The squeezer/strainer device of the present invention comprises a flexible silicone sheet material with a liquid-impermeable border region framing a perforated central region. The perforated central region contains a plurality of perforations having a size of about 0.5 millimeters to about 1.5 millimeters.

### FIELD OF THE INVENTION

The present invention relates to kitchenware. In particular, the invention relates to an elastomeric porous sheet having multiple functions, such as a squeezer, strainer, juicer, sieve, sachet, poacher, steamer, under board stabilizer, and jar lid gripper.

### BACKGROUND OF THE INVENTION

Food preparation frequently requires separating components of a particular ingredient or ingredients, or removing liquid portions of an ingredient from the solid portions thereof. The liquid portion may be either the portion retained for use or the portion discarded. Similarly, the solid portion may be the part retained or discarded. In some instances, both the liquid and solid portions may be retained.

For example, the juice from fruit, such as a lemon, is frequently removed from the solid portions of the fruit in order to utilize the juice in a purer form. Moisture is squeezed from cooked spinach when used as an ingredient in other dishes so that the finished product is not watery and lacking in flavor. Similarly, moisture is squeezed from chopped parsley to concentrate its flavor and to enhance its appearance when used as a garnish.

Juice from grated ginger or other spices is frequently removed from the solid spice components to obtain a more concentrated spiced substance or to obtain the juice itself. Likewise, solid herbs, spices and vegetables such as parsley stems, bay leaves, peppercorns, thyme, cloves and garlic are frequently tied together in a cheesecloth sachet. The sachet is placed in a stock or other dish containing liquid, such as a stew, during the cooking process to create a flavored liquid without the solid portions of the contents entering the liquid. The sachet is then easily removed from the finished product.

Semi-liquid substances such as yogurt and tofu are frequently strained to remove excess moisture to make the substances thicker. Sauces are sometimes strained to remove any solid component, resulting in a smooth liquid. Powdered or granulated substances such as flour or sugar are frequently sieved to remove clumps or relatively large particles from smaller-sized particles.

Devices known in the prior art can be used to separate food components. For example, conventional cheesecloth can be used as a strainer to remove juice and moisture from food items. Cheesecloth has several disadvantages, however. Cheesecloth must be cut to size for the specific task undertaken. Cheesecloth is relatively expensive and generally used only once and then discarded. As such, a user must continually replenish the cheesecloth supply, and might not always have the necessary amount of material readily available on short notice. The non-reusable nature of cheesecloth increases the financial expense and the negative environmental impact from its use.

Although in some circumstances cheesecloth may be reused after washing and drying, it may retain flavors and colors that can be undesirably conveyed during subsequent uses. Washing and drying cheesecloth is time consuming and difficult and it generally does not withstand repeated washings and dryings. In addition, a portion of the strained liquid is frequently absorbed into the cloth material and wasted and lint material from the cheesecloth can contaminate the strained liquid. Cheesecloth also has low elasticity, and therefore is difficult to use to squeeze a substance.

Juicers and strainers made from reusable materials are known in the art, but these devices also have several disadvantages. For example, flexible strainers and colanders such as those shown in U.S. Pat. No. 7,325,694 (Bushey) and U.S. Design Pat. No. 526,541 (Repp) can be made from reusable materials. The reusable strainers known in the art do not have the pliability and elasticity necessary to efficiently and easily squeeze an item to maximize moisture extraction.

Juicers and squeezers made from rigid materials such as plastic or glass also lack pliability and elasticity that can advantageously assist in extracting moisture from an item. In addition, these types of devices typically have only a single dedicated use of juicing specific sized food items, but occupy a disproportionately large amount of kitchen space to achieve this dedicated task.

In view of the foregoing, there is an ongoing need to develop a new squeezing and straining device that will address one or more of the problems with the prior art devices.

### SUMMARY OF THE INVENTION

The present invention relates to a resilient elastomeric squeezer/strainer device.

In one embodiment of the current invention, an elastomeric squeezer/strainer comprises or consists of a flexible silicone sheet material having a liquid-impermeable border region framing a perforated central region. The perforated central region defines a plurality of perforations each having an opening of about 0.2 to about 1.8 square millimeters (e.g. a diameter of about 0.5 millimeters to about 1.5 millimeters) for a circular perforation and being spaced about 25 to about 100 perforations per square inch (or about 4 to about 16 perforations per square centimeter). The flexible silicone sheet has a thickness of about 0.01 inches (about 0.25 millimeters) to about 0.1 inches (about 2.5 millimeters). The flexible silicone sheet preferably has a Shore A durometer value in the range of about 30 A to about 50 A, a tensile strength in the range of about 700 pounds per square inch (about 49 kilograms per square centimeter) to about 1100 pounds per square inch (about 77 kilograms per square centimeter), a stretch limit in the range of about 300% to about 400%, and a density in the range of about 60 pounds per cubic foot (about 0.96 grams per cubic centimeter) to about 80 pounds per cubic foot (about 1.3 grams per cubic centimeter). The plurality of perforations in the perforated central region can be substantially randomly distributed or can be uniformly arrayed in linear rows, concentric circles or any other geometric configuration or combinations of such configurations. Preferably, the perforated central region encompasses about 20% to about 80% of the surface area of the flexible silicone sheet, and more preferably about 40% to about 60% of the surface area of the flexible silicone sheet.

In another preferred embodiment of the elastomeric squeezer/strainer, the perforated central region defines a plurality of perforations spaced about 5 to about 11 perforations per square centimeter. The flexible silicone sheet has a thickness of about 0.25 millimeters to about 0.75 millimeters. The flexible silicone sheet preferably has a Shore A durometer value in the range of about 35 A to about 45 A, a tensile strength in the range of about 49 kilograms per square centimeter to about 77 kilograms per square centimeter, a stretch limit in the range of about 300% to about 400%, and a density in the range of about 1.1 grams per cubic centimeter to about 1.2 grams per cubic centimeter. The plurality of perforations in the perforated central region can be substantially randomly distributed or can be uniformly arrayed in linear rows, concentric circles or any other geometric configuration or combinations of such configurations. Preferably, the perforated central region encompasses about 40% to about 60% of the surface area of the flexible silicone sheet.

In some embodiments, the perforated central region is substantially centered within the impermeable border region.

In a preferred embodiment, the squeezer/strainer is substantially square and the perforated central region comprises rows of substantially uniformly spaced perforations arranged in a substantially square array. In another preferred embodiment, the squeezer/strainer is substantially square and the perforated central region is substantially circular. In another preferred embodiment, the squeezer/strainer is substantially square and the perforated central region defines a substantially circular array of perforations. Alternatively, the squeezer/strainer can be generally circular, oval, or any other shape that might be desired for practical or aesthetic purposes.

In some preferred embodiments, the plurality of perforations comprise circular perforations although squares and other geometric forms can be used, if desired. In a particularly preferred embodiment, the squeezer/strainer is free of enclosing walls and is capable of adopting a substantially planar configuration.

The present invention also relates to a method of expressing liquids from food items. In one preferred embodiment, a liquid-containing food item is enfolded within the squeezer/strainer of the present invention so that at least a portion of the food item contacts the perforated central region of the squeezer/strainer. The flexible silicone sheet material is then compressed around the food item with sufficient force to express liquid from the food item.

A wide variety of food items can be squeezed and/or strained with the squeezer/strainer of the present invention, including fruits, vegetables, spices, sauces, and soups.

Various features, aspects, objects, and advantages of the present invention are illustrated in the following detailed description and appended claims. In the Figures, reference numbers having the same last two digits designate elements that perform a similar function in the depicted structures.

### BRIEF DESCRIPTION OF DRAWINGS

FIG. 1 is a top plan view of a squeezer/strainer according to one embodiment of the present invention.

FIG. 2 is a cross-section of the squeezer/strainer of the sheet of FIG. 1 illustrating perforations through the sheet material of the squeezer/strainer.

FIG. 3A is a perspective view of a squeezer/strainer according to one embodiment of the present invention.

FIG. 3B is the squeezer/strainer of FIG. 3A in a relaxed state.

FIG. 3C is the squeezer/strainer of FIG. 3A folded around a food item, and secured by hand.

FIG. 3D is the squeezer/strainer of FIG. 3C being compressed around a food item to express liquid from the food item.

FIG. 3E is the squeezer/strainer of FIG. 3B with a tie around a portion of the squeezer/strainer.

FIG. 4A is a plan view of a square shaped squeezer/strainer having a round perforated central region.

FIG. 4B is a plan view of a square shaped squeezer/strainer having a round perforated central region forming a ring around an interior circle with no perforations.

FIG. 4C is a plan view of a round shaped squeezer/strainer having a round perforated central region.

FIG. 5 is a plan view of a rectangular squeezer/strainer of the current invention.

### DETAILED DESCRIPTION OF THE INVENTION

The present invention is to a straining/squeezing device that addresses some of the problems of devices known in the prior art. Preferred embodiments of the invention are shown in the drawings and described below in detail. The invention disclosed herein is, of course, susceptible of being embodied in many different manners. The present disclosure exemplifies the principles of the invention and does not limit the invention to the illustrated embodiments.

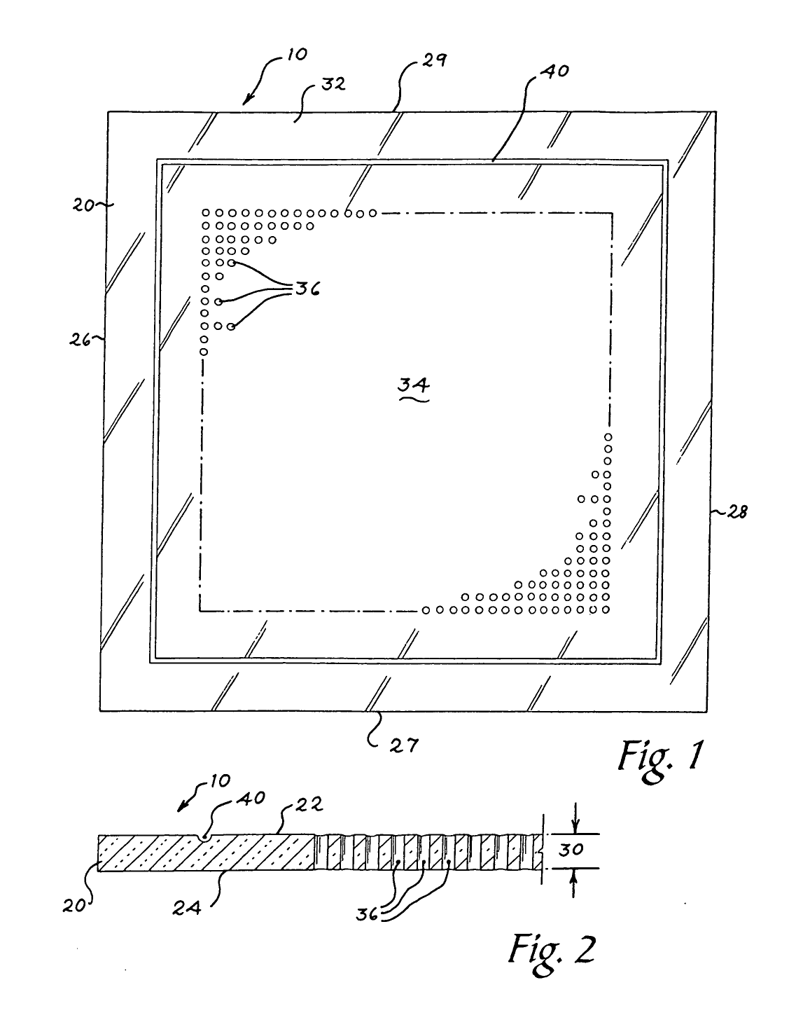

FIGS. 1 and 2 show a first embodiment of an elastomeric squeezer/strainer according to the present invention. FIG. 1 provides a top plan view of an elastomeric squeezer/strainer 10. The elastomeric squeezer/strainer 10 comprises sheet 20 with a first side 22 and a second side 24. As shown in FIG. 2, sheet 20 has a thickness 30. Sheet 20 is constructed of a silicone material.

The term “silicone” (also called polymerized siloxane or polysiloxane) as used herein and in the appended claims refers to mixed inorganic-organic polymers that include silicon together with carbon, hydrogen, oxygen, and optionally other elements. Silicones generally are represented with the chemical formula (R₂SiO)ₙ, where R is an organic group (e.g., alkyl, aryl, arylakyl, alkylaryl, and the like) such as methyl, ethyl, phenyl, benzyl, tolyl, and the like. Optionally, silicone organic groups can be substituted with functional groups such as halogen, anamine, anether and the like, although such substitutable materials are not preferred in the invention. Silicones have a wide variety of physical forms, ranging from liquids to semi-solids to solids. The particular silicone materials suitable for use in the current invention are solid silicone rubber sheets. Such silicone rubber sheets can be made from liquid-injection-molding, heat-curing or any other manufacturing process known in the art.

Silicone rubber sheets are particularly advantageous for use in the current invention because of some of their unique physical features. Silicone rubber sheets are generally thermally stable over a wide range of temperatures, and can be used in high or low temperatures without the material degrading or becoming inoperative or damaged. Silicone rubber sheets of the type known in the art are thermally stable at temperatures from about negative 70° C. to about 260° C. Silicone rubber used to construct sheet 20 preferably is thermally stable from a range of about negative 70° C. to about 235° C. Silicone rubber's thermal stability in this particular range is advantageous for the intended use of squeezer/strainer 10. The squeezer/strainer can come into contact with materials of high temperature (such as food items coming directly from the stovetop, the oven, or from boiling water) without damaging the squeezer/strainer. The squeezer/strainer can also be used on the stovetop in or above liquid or in the oven when placed completely in a pot or other receptacle on the stovetop or in the oven.

Silicone rubber also has an insulating property that limits temperature transmission through the material. Silicone rubber having a relatively small thickness can drastically limit temperature transmission. The insulating properties of the silicone rubber will limit the discomfort to the user from handling items with extremely high or low temperatures.

Squeezer/strainer 10 should be constructed from a silicone material having a hardness, tensile strength, stretch limit, density and thickness that provides sufficient strength and durability to allow multiple uses without breaking or tearing, while at the same time being sufficiently flexible and stretchable to allow food items to be enfolded and compressed in an efficient manner.

Silicone rubber known in the art can have a variety of hardness levels, ranging from extra-soft (such as 35 on Shore OO durometer scale) to extra-hard (such as 65 on a Shore D durometer scale).

In a preferred embodiment of the invention, sheet 20 is constructed from medium soft silicone rubber having a Shore A durometer value in the range of about 10 A to about 60 A, and more preferably in the range of about 30 A to 50 A. Silicone rubber having this durometer value is particularly suited for compressing a food item according to the present invention, because the silicone is sufficiently pliable and elastic to allow a large amount of contact between the squeezer/strainer and the food item. Harder silicone rubber having a higher durometer value is more rigid and does not contact the food item in an advantageous or efficient manner, and is not easily squeezed.

Silicone rubber known in the art can have a variety of flexibility levels, which is referred to herein as a stretch limit percentage. The stretch limit percentage represents the amount a structure can be stretched from its original size without being damaged. For example, a structure having a 200% stretch limit can be stretched to twice its resting size without damaging or irreversibly deforming the structure. In a preferred embodiment of the invention, sheet 20 is constructed from silicone rubber having a stretch limit in the range of about 300% to about 400%. Silicone rubber having this feature can be stretched to 3 or 4 times its resting size without damage to the material. Silicone rubber is resilient, and will return to its original size once stretching force is removed. This ability to recover to original size without deformation or damage is important to the squeezer/strainer's 10 ability to be reused multiple times.

The stretchability and elasticity of sheet 20 increases a user's ability to effectively and efficiently compress food items. Such silicone rubber advantageously stretches during compression to maximize the squeezing or wringing force applied to a food item. This additional force supplied by the elastomeric nature of the silicone rubber differs from the force that can be applied to a food item by compressing conventional materials known in the art, including silicone devices with less flexibility or ordinary cheesecloth.

Silicone rubber known in the art can have a variety of tensile strengths, which is a measure of the maximum stress a material subjected to stretching load can withstand without tearing. In a preferred embodiment of the invention, sheet 20 is constructed from silicone rubber having a tensile strength in a range of about 700 pounds per square inch to about 1100 pounds per square inch (or in a range of about 49 kilograms per square centimeter to about 77 kilograms per square centimeter). Silicone rubber having this tensile strength is particularly suited for use in the present invention, because it allows the squeezer/strainer to be used multiple times to compress food items with no damage to the squeezer/strainer. Such silicone rubber is not fragile, and can withstand ordinary forces required to wash the squeezer/strainer multiple times.

Silicone rubber known in the art can have a variety of densities. In a preferred embodiment of the invention, sheet 20 is constructed from silicone rubber having a density in the range of about 60 pounds per cubic foot (about 0.96 g/cm³) to about 80 pounds per cubic foot (about 1.28 g/cm³), and more preferably about 70 pounds per cubic foot (about 1.12 g/cm³).

Silicone rubber sheets in the art can have a variety of thicknesses. In a preferred embodiment of the invention, sheet 20 has a thickness 30 in a range of about 0.01 inches to about 0.1 inches (about 0.254 millimeters to about 2.54 millimeters), and more preferably in a range of about 0.015 to about 0.025 inches (about 0.381 millimeters to about 0.635 millimeters). Silicone rubber sheets having this thickness are particularly suited for use in the present invention, because they allow the squeezer/strainer 10 to be folded and stretched easily while at the same time retaining strength to prevent the squeezer/strainer 10 from tearing or breaking during use. Rubber sheets having a larger thickness cannot as easily enfold or compress a food item.

The silicone rubber of the present invention is preferably chemically inert, and FDA compliant for use with food. Such silicone rubber can contact food items without absorbing flavors, colors, odors or other chemical properties of the food items. This preferred physical property allows the squeezer/strainer 10 to be used to compress food items without squeezer/strainer 10 becoming contaminated with substances from the food item. It also allows the squeezer/strainer 10 to be cleaned without becoming contaminated with cleaning agents such as detergents and solvents. After cleaning, the chemically inert silicone rubber can contact other food items without cross-contaminating these other food items with the chemical properties of previously contacted food items or cleaning agents.

Silicone rubber suitable for use in the invention can have a variety of visual appearances. Pigments and/or dyes can be included in the silicone material to impart color and/or to affect the degree of transparency of the material. Preferably, inorganic pigments that are chemically inert and approved for food contact are utilized for imparting color or opacity to the material. In one embodiment, sheet 20 can be colorless and transparent. In other embodiments, the sheet 20 can be semi-opaque or fully opaque. The sheet 20 can be constructed of silicone rubber of any color. The color of sheet 20 will not affect the functionality of the squeezer/strainer 10, and can be varied to make it attractive or to comply with the ornamental preferences of the user. In addition, the squeezer/strainer 10 can be created in different colors to allow the user to apply a color-coding scheme for dedicating of a particularly colored squeezer/strainer 10 to a specific use, if so desired.

Silicone rubber suitable for use in the invention can have a variety of surface finishes on one or both sides. Silicone rubber having a smooth finish is advantageous for use in the present invention, because it allows the squeezer/strainer 10 to be easily cleaned. Silicone rubber having a textured finish (such as cross-hatched or gnarled) is advantageous for use in the present invention, because it allows the squeezer/strainer to be easily handled and also increases the gripping properties of the squeezer/strainer. Silicone rubber having a non-skid finish is advantageous for use in the present invention, because it increases the gripping properties of the squeezer/strainer.

Multiple surface finishes can be advantageously combined into a single squeezer/strainer 10. For example, first side 22 can have a smooth surface finish, and second side 24 can have a cross-hatched finish. The cross-hatched side can be placed away from the food item where the food item to be strained contains seeds or pulp or that otherwise could become undesirably caught in the cross-hatched finish. The cross-hatched side can be placed toward the food item in situations where a high gripping force on the food item is desired.

In another example, only a certain portion or portions of an otherwise smooth sheet 20 can contain cross-hatched texture. For example, any or all of corners of sheet 20 could contain cross-hatched texture on both sides to allow a user to easily grip the squeezer/strainer 10 at this particular site when the squeezer/strainer is covered with slippery liquids. These and other combinations of textures may be advantageously used in the present invention.

With reference back to FIG. 1, in one preferred embodiment of the invention, sheet 20 of squeezer/strainer 10 has four edges 26, 27, 28, and 29 and is generally square-shaped. The corners between edges can be rounded corners or sharp, linear corners.

In a non-stretched and resting state, the edges of the sheet 20 have a length preferably in the range of about 6 inches to 30 inches (about 15 cm to about 75 cm), and more preferably about 12 inches in length (about 30 cm). Opposite edges 26, 28 can have a different size than edges 27, 29 if a rectangular-shaped sheet 20 is preferred (such as the rectangular sheet shown in FIG. 5).

Squeezer/strainer 10 contains border region 32 along the outer perimeter of sheet 20. Border region 32 is substantially-free of perforations and is generally liquid impermeable. Border region 32 can have the same surface finish as the rest of sheet 20, or can have a different surface finish (such as cross-hatching) from the rest of sheet 20. Border region 32 can also contain ornamental or decorative designs, if desired.

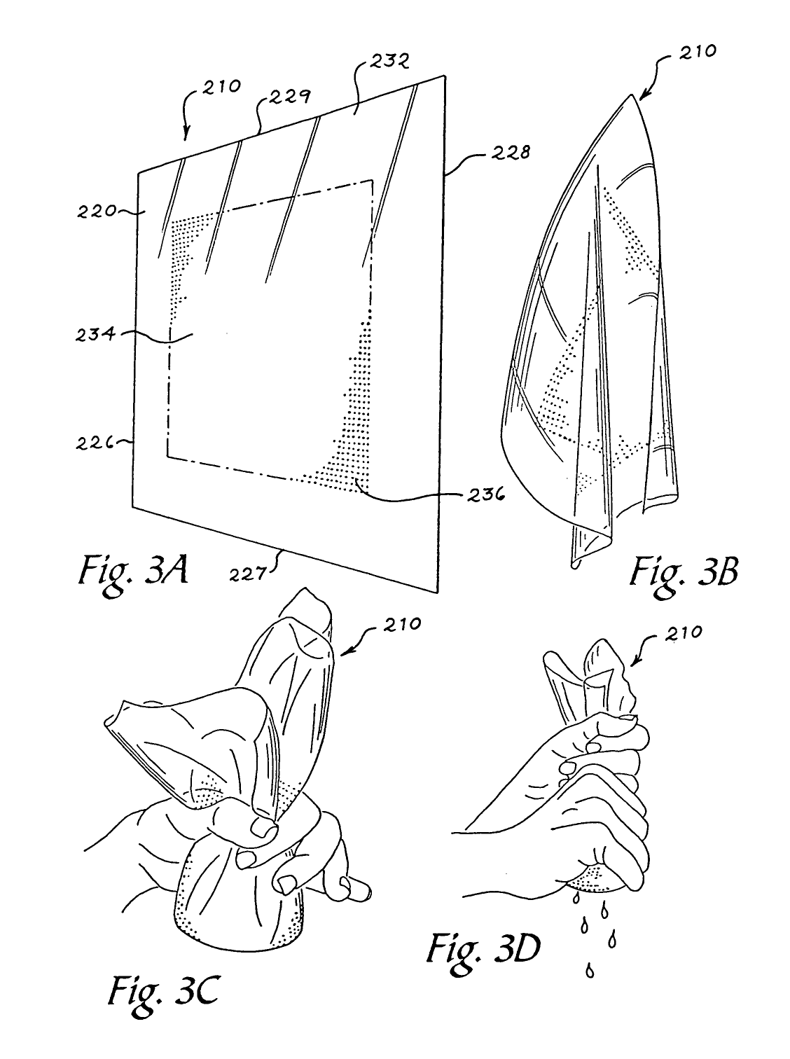

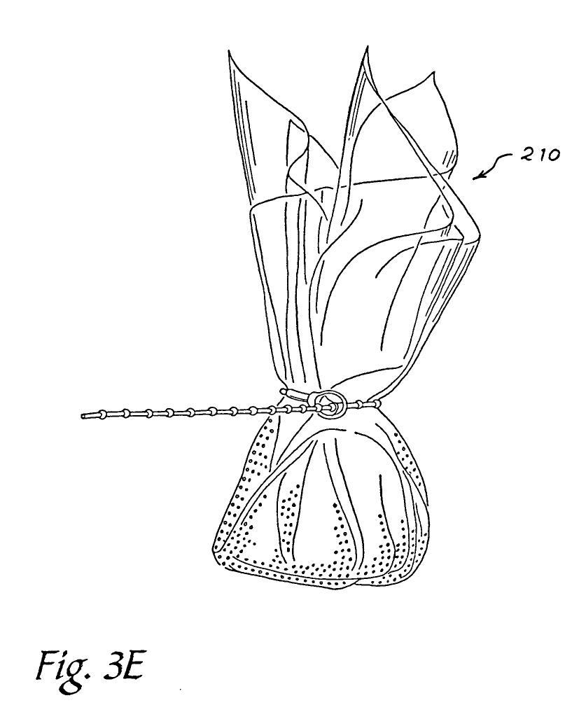

For example, in the embodiment shown in FIGS. 1 and 2, the border region 32 contains a decorative groove 40. The decorative groove 40 in FIGS. 1 and 2 is the same square shape as the square squeezer/strainer of that embodiment. The decorative design in the border region can be any shape and size desired, including ridges extending above the surface of sheet 20, and curved or other non-linear shapes. The border region 32 can also be substantially free of any decorative design, such as in the embodiments shown in FIGS. 3-5.

Squeezer/strainer 10 has a perforated central region 34 framed by border region 32. Perforated central region 34 contains a plurality of perforations 36. As shown in FIG. 2, perforations 36 are perforations that extend through the thickness 30 of sheet 20. These perforations 36 allow material (such as liquid) to travel from first side 22 to second side 24 of sheet 20.

Perforations 36 can have a variety of shapes and sizes. For example, perforations 36 can be oblong slits, square-shaped holes, round holes, ovoid holes, and the like. In a preferred embodiment, perforations 36 are circular (such as the perforations shown in FIG. 1).

Perforations 36 preferably are sized so that small particles and liquids can pass through, but larger solid materials cannot pass through the perforations 36. In a preferred embodiment with reference to circular perforations, each perforation 36 has a size (i.e. diameter) in the range of about 0.5 millimeters to about 1.5 millimeters (about 0.02 inches to about 0.06 inches), and more preferably about 1 millimeter (about 0.04 inches). The size of the perforations can be larger or smaller than the recited range depending upon the intended application for squeezer/strainer 10. For example, if it is desirable to allow more boiling, simmering or steaming water or other liquid to come in contact with the food item enclosed when poaching or steaming, perforations 36 can be sized larger than 1.5 millimeters in diameter. Likewise, if the squeezer/strainer 10 is used to contain materials (such as sugar, flour or ground spices) having a very small particle size, perforations 36 can be sized smaller than 0.5 millimeters in diameter.

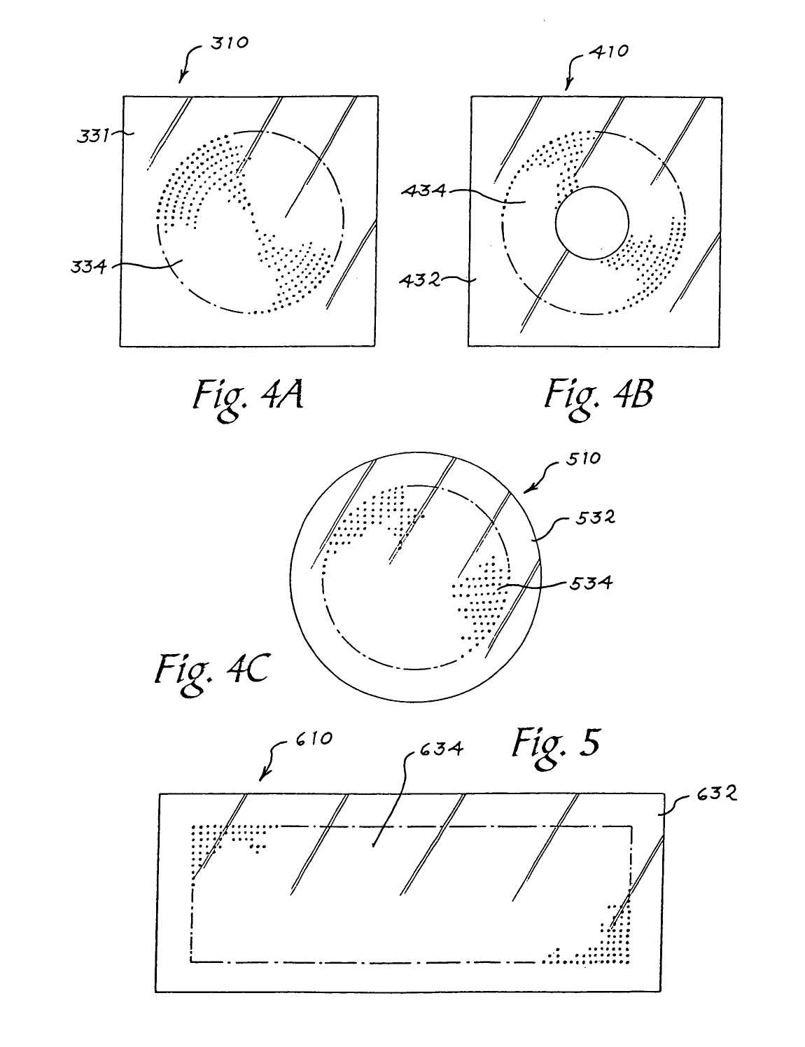

The number and spacing of perforations 36 within perforated central region 34 is relevant to the optimal functioning of the present invention. The perforation density in the perforated central region 34 ranges generally between about 25 and 100 perforations per square inch (about 4 to 16 perforations per square centimeter). In a preferred embodiment, perforations 36 are substantially-evenly distributed in a range of about 30 perforations per square inch (about 5 perforations per square centimeter) to about 70 perforations per square inch (about 11 perforations per square centimeter), and more preferably about 50 perforations per square inch (about 7 perforations per square centimeter). The perforations can be aligned in linear rows (such as shown in FIG. 1), concentric circles (such as shown in FIG. 4) or any other arrangement that might be desired.

The size, shape and density of the perforations can change as the squeezer/strainer 10 is stretched. For example, a circular perforation can become oval-shaped and the diameter and area of a perforation can increase as the squeezer/strainer 10 is stretched. The perforation characteristics discussed herein refer to the perforations as they exist when the squeezer/strainer 10 is in a resting and non-stretched state.

Perforations of this density are advantageous over other devices having a small number of perforations through which material can pass. This density of perforations allows multiple perforations to come into contact with the surface of the food item as it is being squeezed or strained. This perforation density also allows juice to flow through the device more quickly and easily than prior art lemon squeezers with one or very few perforations. Seeds and pulp are less likely to clog the perforations in squeezer/strainer 10 as they might with a device with one or few perforations. The density of perforations also makes the device extremely efficient for quickly squeezing the moisture out of cooked spinach and for straining solids from liquid when making a sauce or stock.

The perforated central region 34 can have a variety of shapes relative to the border region 32. For example, the perforated central region 34 can be the same shape as sheet 20 (such as a square central region 34 within a square sheet 20 in FIG. 1).

As shown in FIGS. 4-5, the perforated central region can be shaped other than in a square shape. For example, the perforated central can be a circular central region such as central regions 334, 434, 534 shown in FIGS. 4A, 4B, 4C, respectively. With specific reference to FIG. 4B, the central region 434 can be ring-shaped having an interior circle with no perforations. The perforated central region can also be a rectangular central region such as central region 634 shown in FIG. 5. The perforation size, shape and concentration of these various central regions can be varied as described herein.

The perforated central region 34 can also be formed in a decorative shape to increase the aesthetics of squeezer/strainer 10. For example, the perforated central region 34 can be shaped to represent any number of objects, such as a star or a moon, a logo, a football, or a food item such as a lemon.

Perforated central region 34 can have a variety of sizes relative to border region 32. In one preferred embodiment, the sheet 20 is an approximately 12 inch by 12 inch square (about 30.5 centimeters by 30.5 centimeter) having an approximately 8 inch by 8 inch (about 20.3 centimeter by 20.3 centimeter) perforated central region 34, and an approximately 2 inch (about 5.1 cm) border region adjacent each edge 26, 27, 28, 29 of sheet 20 (when the squeezer/strainer 10 is in a non-stretched, resting state). The perforated central region 34 preferably encompasses only a portion of sheet 20. In a preferred embodiment, perforated central region 34 encompasses about 20% to about 80% of the surface area of sheet 20. More preferably, the perforated central region encompasses about 40% to 60% of the surface area of sheet 20.

For example, in an embodiment having an about 12 inch by 12 inch sheet and an about 8 inch by 8 inch perforated central region 34, about 45% of the sheet 20 comprises perforated central region 34. The inclusion of perforated regions and non-perforated regions in a single squeezer/strainer 10 allows for the direction of the liquid expelled from a food item to be more easily controlled and, depending on the size of the food enclosed, prevents or reduces direct hand-to-food contact.

A percentage of the surface area of the perforated central region 34 comprises open voids that extend from side 22 to side 24. This percentage of open space varies depending upon the size and density of the perforations 36 in the perforated central region 34. In a preferred embodiment, perforations 36 collectively encompass about 1% to 30% of the surface area of the perforated central region 34.

With specific reference to FIG. 3, squeezer/strainer 210 consists of a flexible sheet material 220 that can assume a substantially planar configuration and is substantially free from enclosing walls. This absence of enclosing walls is particularly advantageous to the present invention because it increases the versatility of squeezer/strainer 210. Enclosing walls create a fixed size that limit the types and sizes of foods that can be enclosed by a squeezer/strainer. For example, a squeezer/strainer with enclosing walls sized to contain a lemon could not enclose a larger-sized food item such as a grapefruit.

The substantially planar configuration of sheet 220 allows food items having a wide-variety of shapes and sizes to be enfolded within squeezer/strainer 210. Sheet 220 can be folded around a food item without resort to fixed enclosing walls. For example, a small food item such as a lime can be enclosed by squeezer/strainer 210 by folding up the edges of sheet 220 to create a relatively small cavity. Likewise, a larger food item such as a quantity of cooked spinach can be enclosed by the same squeezer/strainer 210 by folding up the edges of sheet 220 to create a larger cavity than the cavity enclosing a lime.

The design simplicity of squeezer/strainer 210 increases the versatility of the present invention by allowing it to be used for a wide variety of applications.

Squeezer/strainer 210 can be used as a device to remove and strain liquid from a liquid-containing food item. As shown in FIG. 3C, a food item is placed on perforated central region 234 of sheet 220, and edges 226, 227, 228, 229 are folded together to envelop the food item. The food item is then compressed with a squeezing or wringing force so that liquid is expelled from the food item, as shown in FIG. 3D. This liquid passes through perforations 236 and out of squeezer/strainer 210, while the solid portion of the food item remains enveloped in the folded squeezer/strainer 210. The size and shape of the squeezer/strainer 210 is particularly advantageous for this application, because the squeezer/strainer can be folded up and held with one hand, and squeezed with a second hand, as shown in FIG. 3D. Once the desired amount of liquid is removed from the food item, the edges of squeezer/strainer 210 can be unfolded and the remaining food item can be removed to be saved or discarded. Squeezer/strainer 210 can then be washed.

A wide variety of food items can be squeezed and strained in this manner using the present invention. Such food items include fruit (including but not limited to lemons, limes, oranges, tangerines, grapefruits, pomegranate seeds, and melons), vegetables (including but not limited to spinach and other greens), and herbs and spices (including but not limited to chopped ginger, parsley and cilantro), meats, yogurt, custard, tofu, jams, and jellies.

Squeezer/strainer 10 can also be used to separate liquid and solid components when making a sauce or stock. Squeezer/strainer 10 can then be used to compress the solids for the purpose of extracting flavor from the solids in order to maximize the flavor of a sauce or stock. In this application, a fine-mesh strainer or sieve with a handle is placed over a deep bowl or other receptacle. Squeezer/strainer 10 is used to line the fine-mesh strainer or sieve so that the perforated central region 34 of the sheet 20 is centered in the strainer or sieve. The liquids and solids are then transferred into squeezer/strainer 10. The liquid passes through perforations 36 and out of squeezer/strainer 10 into the bowl or receptacle and the solid items larger than perforations 36 are constrained to squeezer/strainer 10. Squeezer/strainer 10 is then removed from the strainer or sieve. The edges 26, 27, 28, 29 are folded together to envelop the food item and secured closed (advantageously with one hand). The solids are then compressed (advantageously with the other hand) with a squeezing or wringing force so that the flavor is extracted from the solids.

Squeezer/strainer 10 can also be used as a sieve to strain food items (such as soups and liquid stocks) where compression force is unnecessary to expel liquid from the food item. The food item to be sieved can also be a non-liquid food item such as flour or sugar. In this particular application, squeezer/strainer 10 can be placed over the rim of a deep bowl or other receptacle such that all of the perforations 36 are located inside of the rim of the receptacle and the liquid impermeable border region 32 is located on the rim or outside the rim. Sheet 20 can be formed into a concave configuration to ensure all perforations are located inside of the receptacle. Alternately, when used with liquid food items squeezer/strainer 10 can be used to line a fine-mesh strainer or sieve as described above. The food item is then transferred into the squeezer/strainer 10. In the case of liquid food items such as soup, the desired liquid passes through the perforations 36 into the receptacle and solid items larger than perforations 36 are constrained to squeezer/strainer 10. In the case of solid food items such as flour, clumps or lumps can be broken with the back of a spoon or other utensil and the particles then pass through perforations 36 into the receptacle resulting in a powdery and aerated food item.

Squeezer/strainer 10 can also be used as a sachet for flavoring a liquid, soup or stew. In this particular application, solid food items (such as parsley stems, bay leaves, peppercorns, thyme, cloves, or garlic) are placed on perforated central region 34 of sheet 20, and edges 26, 27, 28, 29 are folded together to envelop the food item. Sheet 20 can be tied together to ensure that the food items remain enveloped inside of squeezer/strainer 10. Sheet 20 can be tied with any conventional means, such as cooking twine or a silicone tie (as shown in FIG. 3E). Squeezer/strainer 10 is then placed into a liquid, soup or stew for a desired amount of time. Liquid enters squeezer/strainer 10 through perforations 36 and contacts food items, which in turn adds flavors to the liquid, soup or stew. High temperature liquids (such as boiling water) as well as low temperature liquids can be used in this application.

Squeezer/strainer 10 can also be used as a handling device for high-temperature processes such as steaming, or poaching. In this particular application, squeezer/strainer 10 can be centered in a pot, steamer or other cooking receptacle. A food item (such as a fish fillet) is then placed on squeezer/strainer 10 and edges 26, 27, 28, 29 are folded lengthwise and widthwise as necessary so that squeezer/strainer 10 is located entirely inside the receptacle and completely encloses the food item, which is then cooked (such as by poaching). After the food item is cooked as desired, the food item is removed from the cooking receptacle by unfolding, if necessary, the edges of squeezer/strainer 10. The cook can use tongs to grip edges of squeezer/strainer 10 to lift and remove squeezer/strainer 10 from the cooking receptacle. Liquids used to cook the food item pass through perforations 36 and remain in the cooking receptacle. Silicone rubber's thermal stability at high temperatures is particularly advantageous for this application. Squeezer/strainer 10 facilitates the intact removal of the food item from the receptacle.

The design simplicity of the current invention maximizes efficiency and usefulness by allowing the device to serve multiple functions instead of being dedicated to a specific task. As discussed above, squeezer/strainer 10 has a wide variety of cooking uses. Squeezer/strainer 10 can also be used as a substitute for other kitchen applications that require the use of a generally planar silicone rubber mat. For example, squeezer/strainer 10 can be used as a gripping device to open jar lids. Squeezer/strainer 10 can also be placed under pots or cutting boards to prevent slippage.

The design simplicity of the current invention also promotes easy storage in small spaces, unlike bulky utensils such as juicers, colanders, strainers and sieves. For example, squeezer/strainer 10 can be stored as a flat sheet, or can be rolled into a cylinder to be stored.

In the foregoing description, certain terms have been used for brevity, clarity and understanding, however, no unnecessary limitations are to be implied therefrom because such terms are for descriptive purposes and are intended to be broadly construed. Moreover, the descriptions and illustrations given are by way of example and the invention is not limited to the exact details shown or described.

What is claimed is:

1. A resilient elastomeric squeezer/strainer comprising:
a flexible silicone sheet material including a liquid-impermeable border region framing a perforated central region;
the perforated central region defining a plurality of perforations, each perforation having a size of about 0.5 millimeters to about 1.5 millimeters;
the plurality of perforations comprising about 4 to about 16 perforations per square centimeter; and
the flexible silicone sheet having a thickness of about 0.25 millimeters to about 2.5 millimeters.

2. The squeezer/strainer of claim 1, wherein the flexible silicone sheet material has a Shore A durometer value in the range of about 30 A to about 50 A.

3. The squeezer/strainer of claim 1, wherein the flexible silicone sheet material has a tensile strength in the range of about 49 kilograms per square centimeter to about 77 kilograms per square centimeter.

4. The squeezer/strainer of claim 1, wherein the flexible silicone sheet material has a stretch limit in the range of about 300% to about 400%.

5. The squeezer/strainer of claim 1, wherein the flexible silicone sheet material has density in the range of about 0.96 g/cm³ to about 1.3 g/cm³.

6. The squeezer/strainer of claim 1, wherein the squeezer/strainer is substantially square and the perforated central region comprises rows of substantially uniformly spaced perforations arranged in a substantially square array.

7. The squeezer/strainer of claim 1, wherein the squeezer/strainer is substantially square and the perforated central region is substantially circular.

8. The squeezer/strainer of claim 1, wherein the plurality of perforations are substantially uniformly arrayed in linear rows.

9. The squeezer/strainer of claim 1, wherein the plurality of perforations are substantially uniformly arrayed in concentric circles.

10. The squeezer/strainer of claim 1, wherein the perforated central region encompasses about 20% to about 80% of the total surface area of the flexible silicone sheet.

11. The squeezer/strainer of claim 1, wherein the perforated central region encompasses about 40% to about 60% of the total surface area of the flexible silicone sheet.

12. The squeezer/strainer of claim 1, wherein the squeezer/strainer is free of enclosing walls.

13. The squeezer/strainer of claim 1, wherein the plurality of perforations comprises circular perforations.

14. The squeezer/strainer of claim 1, wherein the squeezer/strainer is capable of adopting a substantially planar configuration.

15. An elastomeric strainer comprising:
a flexible silicone sheet material with a liquid-impermeable border region framing a perforated central region;
the perforated central region defining a plurality of perforations distributed at about 5 to about 11 perforations per square centimeter; and
the flexible silicone sheet having a thickness in the range of about 0.25 millimeters to about 0.75 millimeters, a Shore A durometer value in the range of about 35 A to about 45 A, a tensile strength in the range of about 49 kilograms per square centimeter to about 77 kilograms per square centimeter, a stretch limit of about 300% to about 400%, and a density in the range of about 1.1 g/cm³ to about 1.2 g/cm³.

16. The strainer of claim 15, wherein the perforated central region encompasses about 40% to about 60% of the total surface area of the flexible silicone sheet.

17. The strainer of claim 15, wherein the flexible silicone sheet material is substantially square and the perforated central region defines a substantially square array of perforations.

18. The strainer of claim 15, wherein the flexible silicone is substantially square and the perforated central region defines a substantially round array of perforations.

19. A method of straining items, comprising the steps of:
enfolding a liquid-containing food item within the squeezer/strainer of claim 1 such that at least a portion of the food item contacts the perforated central region of the squeezer/strainer;
compressing the flexible silicone sheet material around the food item with sufficient force to express liquid from the food item.

20. The method of claim 19, wherein the food item is selected from the group consisting of fruits, vegetables, herbs, spices, or a combination thereof.
